(19) United States
(12) Patent Application Publication
(10) Pub. No.: US 2007/0109213 A1
(43) Pub. Date: May 17, 2007

(54) DIRECTION FINDER ANTENNA

(75) Inventor: Teruo Takahashi, Tokyo (JP)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: GENERAL RESEARCH OF ELECTRONICS, INC., Tokyo (JP)

(21) Appl. No.: 11/557,140

(22) Filed: Nov. 7, 2006

(30) Foreign Application Priority Data
Nov. 11, 2005 (JP) 2005-327511

(51) Int. Cl. H01Q 21/00

(52) U.S. Cl. 343/893; 343/901

(57) ABSTRACT

The present invention provides a direction finder antenna that includes an antenna mount having one flat portion and four extensible whip antenna elements respectively upright provided rotatably at antenna upright-provided points formed on one circumference at an antenna upright-provided surface. The four extensible whip antenna elements can be rotatably set to arbitrary angular positions lying in sector-shaped areas each having an open angle of 180° orthogonal to the one circumference, which are formed on the antenna upright-provided surface side, centering on the respective antenna upright-provided points at the antenna upright-provided surface.

### RELATED/PRIORITY APPLICATION

This application claims priority with respect to Japanese Application No. 2005-327511, filed Nov. 11, 2005.

### BACKGROUND OF THE INVENTION

1. Field of the Invention

The present invention relates to a direction finder antenna, and particularly to a direction finder antenna transportable in a compact structure, capable of responding to incoming radio waves lying in a wide frequency range and detecting the direction of the incoming radio waves regardless of the plane of polarization of the radio waves.

2. Description of the Related Art

As direction finder antennas each used in a direction finder, a loop antenna-series one and an Adocock antenna-series one have heretofore been used principally. As antennas that belong to these series, there have been known those of various forms respectively.

Meanwhile, the loop antenna is of an antenna firstly used as the direction finder antenna. The sensitivity of the loop antenna becomes a maximum by aligning an antenna loop plane in a radio-wave incoming direction. In order to perform proper direction finding of the radio-wave incoming direction, this type of loop antenna is used together with an auxiliary antenna or makes use of two loop antennas whose antenna loop planes are placed in an orthogonal state. The loop antenna is easy to cause a directional error depending on the state of polarization of incoming radio waves and cannot be made so high in antenna effective height. Therefore, when an attempt is made to increase a signal-to-noise ratio at the time of receipt of incoming radio waves, there is a need to enlarge the loop shape of the loop antenna, whereas the loop antenna is often used as a vehicle-mounted antenna because it can be formed in a compact structure.

On the other hand, the Adocock antenna is of an antenna invented to reduce the occurrence of a directional error produced due to the state of polarization of incoming radio waves. The Adocock antenna can be obtained by using a vertical doublet antenna or a whip antenna. In this case, the vertical doublet antenna or the whip antenna is one wherein one plane or flat portion of a flat-plate shaped ground substrate is configured as an antenna upright-provided plane or surface and four antenna elements are upright placed on the antenna upright-provided surface at respective square vertex portions of the antenna upright-provided surface. The vertical doublet antenna or the whip antenna differentially combines received outputs of a set of the antenna elements located at one diagonal vertex, of the four antenna elements and takes out the combined received output, and differentially combines received outputs of a set of the antenna elements thereof located at the other diagonal vertex and takes out the combined received output. Then, the vertical doublet antenna or the whip antenna converts the thus-obtained two received outputs into phase angles by using a goniometer or the like and represents azimuth angles using the converted phase angles.

Even in addition to the above, the vertical doublet antenna or the whip antenna sequentially takes out received outputs from the four antenna elements in a rotary scanner manner and detects the same as Doppler shifts from arrival time differences between the taken received outputs (incoming radio waves), and converts the detected outputs to phase angles and represents azimuth angles using the converted phase angles. The representation of these azimuth angles means that the four vertical antenna elements all upright provided on the flat plate-shaped ground substrate are used to directly take the received outputs from the antenna elements or take the same as relative differential outputs, thereby making it possible to reduce directional errors produced due to the state of polarization of the incoming radio waves. In order to enhance the accuracy of detection in the direction of the incoming radio waves, there are known antennas each using a large number of antenna elements (multiple-element antenna) such as eight antenna elements (8-element antenna), sixteen antenna elements (16-element antenna), . . . , or the like as an alternative to the use of the four antenna elements (4-element antenna).

The antenna elements employed in such a vertical antenna, e.g., the doublet antenna or whip antenna is so restricted in the range of frequency radio waves usable in the antenna elements due to the resonance characteristics of those antenna elements. Thus, as this type of doublet antenna or whip antenna, there is also known one in which in order to enlarge the range of the frequency radio waves usable in the antenna elements thereof, such a contrivance that the antenna elements are made thick in structure or the antenna elements are configured as a slender cage-shaped structure to thereby extend the resonance characteristics of the antenna elements to a wide frequency band has been made.

Meanwhile, when the existing condition of a direction finder antenna is viewed, radio waves, which are transmitted from many radio-wave transmitting stations and arrive at the direction finder antenna, respectively vary in the state of polarization thereof depending on transmission forms or modes at the time that the radio waves are transmitted through the air, as well as differing from one another in frequency. Further, the state of polarization thereof slightly varies even depending upon the angle of incidence at which the incoming radio waves are launched into the direction finder antenna.

On the other hand, the above known direction finder antenna takes the structure in which a variation in the frequency of radio waves, a variation in the state of polarization of the incoming radio waves, and the influence of the incident angle of each incoming radio wave on the direction finder antenna are taken into consideration to some extent. It is however difficult to always receive, in a satisfactory state, radio waves which are transmitted from a large number of transmitting stations and respectively have radio wave frequencies different from one another and which arrive at the direction finder antenna according to the different radio-wave transmission forms. The accurate direction finding of the incoming radio waves could not be performed in a uniform state.

### SUMMARY OF THE INVENTION

The present invention has been made in view of such a background art. It is therefore an object of the present invention to provide a direction finder antenna which is brought to a structure in which the state of each antenna element can be arbitrarily changed depending on the state of incoming radio waves and which is capable of performing accurate direction finding of the incoming radio waves regardless of frequency bands for the incoming radio waves and the state of polarization thereof and is transportable in a compact structure.

In order to attain the above object, there is provided a direction finder antenna according to one aspect of the present invention, which is equipped with first means comprising:

an antenna mount having at least one flat portion; and

extensible whip antenna elements of four or more which use the flat portion of the antenna mount as an antenna upright-provided surface and are respectively upright provided rotatably at antenna upright-provided points formed on one circumference at the antenna upright-provided surface,

wherein the extensible whip antenna elements are respectively capable of being rotatably set to arbitrary angular positions lying in sector-shaped areas each having an open angle of 180° orthogonal to the one circumference, which are formed on the antenna upright-provided surface side, centering on the respective antenna upright-provided points at the antenna upright-provided surface.

Also in order to attain the above object, there is provided a direction finder antenna according to another aspect of the present invention, which is equipped with second means comprising:

an antenna mount having at least one flat portion; and

extensible whip antenna elements of four or more which use the flat portion of the antenna mount as an antenna upright-provided surface and are respectively upright provided rotatably at antenna upright-provided points formed on one circumference at the antenna upright-provided surface,

wherein the extensible whip antenna elements are respectively capable of being rotatably set to arbitrary angular positions in hemispherical areas formed on the antenna upright-provided surface side, lying in spherical areas with respective antenna upright-provided points at the antenna upright-provided surface as the centers.

Further, in order to attain the above object, there is provided a direction finder antenna according to a further aspect of the present invention, which is equipped with third means comprising:

an antenna mount having upper and lower surface portions and side surface portions formed so as to connect side edges of the upper surface portion and side edges of the lower surface portion; and

a plurality of extensible whip antenna elements which respectively use the side surface portions of the antenna mount as antenna upright-provided surfaces and are respectively upright provided rotatably at antenna upright-provided points formed at plural equal intervals on a straight line connecting the same vertical positions at the antenna upright-provided surfaces,

wherein the extensible whip antenna elements are respectively capable of being rotatably set to arbitrary angular positions lying in sector-shaped areas each having an open angle of 180° orthogonal to the straight line formed on the antenna upright-provided surfaces sides, centering on the respective antenna upright-provided points at the antenna upright-provided surfaces.

Furthermore, in order to attain the above object, there is provided a direction finder antenna according to a still further aspect of the present invention, which is equipped with fourth means comprising:

an antenna mount having upper and lower surface portions and side surface portions formed so as to connect side edges of the upper surface portion and side edges of the lower surface portion; and

a plurality of extensible whip antenna elements which respectively use the side surface portions of the antenna mount as antenna upright-provided surfaces and are respectively upright provided rotatably at antenna upright-provided points formed at plural equal intervals on a straight line connecting the same vertical positions at the antenna upright-provided surfaces,

wherein the extensible whip antenna elements are respectively capable of being rotatably set to arbitrary angular positions in hemispherical areas formed on the antenna upright-provided surfaces sides, lying in spherical areas with the respective antenna upright-provided points at the antenna upright-provided surfaces as the centers.

According to the direction finder antenna according to the one aspect of the present invention as described above, the direction finder antenna is brought to such a structure that the flat portion of the antenna mount is configured as the antenna upright-provided plane or surface, the extensible whip antenna elements of four or more upright provided rotatably at the respective upright-provided points formed on the antenna upright-provided surface are provided, and the extensible whip antenna elements can respectively be set rotatably to the arbitrary angular positions lying in the sector-shaped areas each having the open angle of 180° orthogonal to the one circumference, which are formed on the antenna upright-provided surface side, centering on the respective antenna upright-provided points. Therefore, the direction finder antenna brings about advantageous effects in that the tilt angles of the extensible whip antenna elements and/or their lengths are arbitrarily changed depending upon the frequency of incoming radio waves and the state of polarization thereof to thereby make it possible to select conditions optimum for the frequency of the incoming radio wave and the plane of polarization thereof respectively, whereby the direction of incoming radio waves lying in a very high frequency band and an ultra high frequency band can be detected accurately regardless of whether the incoming radio waves are horizontally polarized waves or vertically polarized waves, and the direction finder antenna is compact in structure and usable in portable form.

According to the direction finder antenna according to another aspect of the present invention as well, the direction finder antenna is brought to such a structure that the flat portion of the antenna mount is configured as the antenna upright-provided surface, the extensible whip antenna elements of four or more respectively upright provided rotatably at the antenna upright-provided points formed on the antenna upright-provided surface are provided, and the extensible whip antenna elements can respectively be set rotatably to the arbitrary angular positions in the hemispherical areas formed on the antenna upright-provided surface side, lying in the spherical areas with the respective antenna upright-provided points at the antenna upright-provided surface as the centers. Therefore, the direction finder antenna can bring about advantageous effects in that the tilt angles of the extensible whip antenna elements of three or more and/or their lengths are arbitrarily changed depending upon the frequency of incoming radio waves and the state of polarization thereof to thereby make it possible to more freely select conditions optimum for the frequency of the incoming radio waves and the plane of polarization thereof respectively, whereby the direction of incoming radio waves lying in a very high frequency band and an ultra high frequency band can be detected accurately regardless of whether the incoming radio waves are horizontally polarized waves or vertically polarized waves, and the direction finder antenna is compact in structure and usable in portable form.

Further, according to the direction finder antenna according to a further aspect of the present invention, the direction finder antenna is brought to such a structure that the side surface portions of the antenna mount are configured as the antenna upright-provided surfaces, the plurality of extensible whip antenna elements respectively upright provided rotatably at the antenna upright-provided points formed on the antenna upright-provided surfaces are provided, and the plurality of extensible whip antenna elements can respectively be set rotatably to the arbitrary angular positions lying in the sector-shaped areas each having the open angle of 180° orthogonal to the straight line connecting the respective antenna upright-provided points formed on the antenna upright-provided surfaces sides centering on the respective antenna upright-provided points at the antenna upright-provided surfaces. Therefore, the direction finder antenna brings about advantageous effects in that the tilt angles of the plural extensible whip antenna elements and/or their lengths are arbitrarily changed depending upon the frequency of incoming radio waves and the state of polarization thereof to thereby make it possible to select conditions optimum for the frequency of the incoming radio wave and the plane of polarization thereof respectively, whereby the direction of incoming radio waves lying in a very high frequency band and an ultra high frequency band can be detected accurately regardless of whether the incoming radio waves are horizontally polarized waves or vertically polarized waves, and the direction finder antenna is compact in structure and usable in portable form.

Furthermore, according to the direction finder antenna according to a still further aspect of the present invention, the direction finder antenna is brought to such a structure that the side surface portions of the antenna mount are configured as the antenna upright-provided surfaces, the plurality of extensible whip antenna elements respectively upright provided rotatably at the antenna upright-provided points formed on the antenna upright-provided surfaces are provided, and the plural extensible whip antenna elements can respectively be set rotatably to the arbitrary angular positions in the hemispherical areas formed on the antenna upright-provided surfaces sides, lying in the spherical areas with the respective antenna upright-provided points at the antenna upright-provided surfaces as the centers. Therefore, the direction finder antenna brings about advantageous effects in that the tilt angles of the plural extensible whip antenna elements and/or their lengths are arbitrarily changed depending upon the frequency of incoming radio waves and the state of polarization thereof to thereby make it possible to more freely select conditions optimum for the frequency of the incoming radio waves and the plane of polarization thereof respectively, whereby the direction of incoming radio waves lying in a very high frequency band and an ultra high frequency band can be detected accurately regardless of whether the incoming radio waves are horizontally polarized waves or vertically polarized waves, and the direction finder antenna is compact in structure and usable in portable form.

Other features and advantages of the present invention will become apparent upon a reading of the attached specification.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 shows a first embodiment of a direction finder antenna according to the present invention and is a perspective view showing a configuration of its essential part;

FIG. 2 illustrates a second embodiment of a direction finder antenna according to the present invention and is a perspective view depicting a configuration of its essential part;

FIG. 3 depicts a third embodiment of a direction finder antenna according to the present invention and is a perspective view and a top view showing a configuration of its essential part;

FIG. 4 is a perspective view showing the states of changes in extensible whip antenna elements of the direction finder antenna shown in FIG. 3; and

FIG. 5 is a top view showing each of examples illustrative of other forms of antenna mounts employed in a direction finder antenna according to the present invention.

### DETAILED DESCRIPTION OF THE PREFERRED EMBODIMENTS

Preferred embodiments of direction finder antennas according to the present invention will be explained hereinafter with reference to the accompanying drawings.

### First Preferred Embodiment

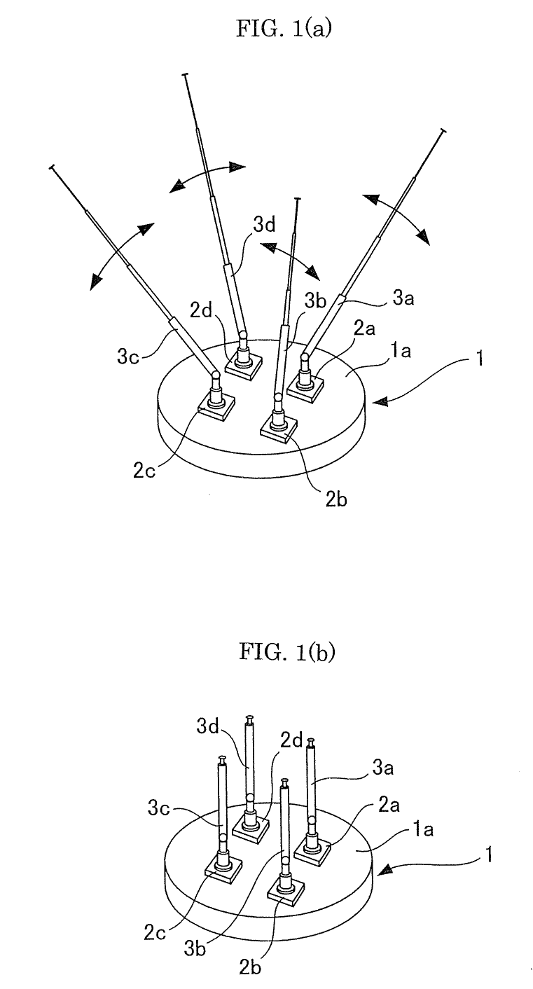

FIGS. 1(a) and 1(b) show a first embodiment of a direction finder antenna according to the present invention and are perspective views each illustrating a configuration of its essential part, wherein FIG. 1(a) shows the state of four extensible whip antenna elements at the time that their lengths and their tilt angles are respectively adjusted to the optimum state with respect to incoming radio waves, and FIG. 1(b) shows the state of the four extensible whip antenna elements at the time that they are respectively adjusted to their shortest lengths and upstanding angles.

As shown in FIGS. 1(a) and 1(b), the direction finder antenna according to the first embodiment comprises an antenna mount 1 disc-shaped and formed with a flat or plane portion 1a on one main surface thereof, four antenna holding portions 2a, 2b, 2c and 2d disposed on the flat portion 1a and formed with slide bearings, and four extensible whip antenna elements 3a, 3b, 3c and 3d respectively held by the antenna holding portions 2a, 2b, 2c and 2d and upright provided rotatably on the flat portion 1a. In this case, the four antenna holding portions 2a, 2b, 2c and 2d are disposed at equal intervals on one circumference formed on the flat portion 1a. The ranges in which the four extensible whip antenna elements 3a, 3b, 3c and 3d respectively held by the four antenna holding portions 2a, 2b, 2c and 2d are rotatable, are rotatably placed within sector-shaped areas each having an open angle of 180° formed in the direction of the radius of the one circumference formed on the antenna upright-provided surface side, i.e., in the direction orthogonal to the one circumference and can be rotatably set to arbitrary angular positions in the sector-shaped areas, with the four antenna holding portions 2a, 2b, 2c and 2d corresponding to antenna upright-provided points of the four extensible whip antenna elements 3a, 3b, 3c and 3d as the centers.

If, where the frequency of the incoming radio wave is close to an adaptable highest frequency of each of the four extensible whip antenna elements 3a, 3b, 3c and 3d and the state of polarization of the incoming radio wave is a vertically polarized wave in the direction finder antenna having the above configuration, the lengths of the four extensible whip antenna elements 3a, 3b, 3c and 3d are respectively placed in a reduced state in such a way as to be brought to the shortest length, i.e., a length close to one quarter-wavelength of the highest frequency, and the four extensible whip antenna elements 3a, 3b, 3c and 3d are respectively set so as to be vertical to the flat portion 1a, as illustrated in FIG. 1(b), then the corresponding incoming radio wave can be received in a satisfactory state with a high degree of antenna efficiency.

On the other hand, if, where the frequency of the incoming radio waves is close to adaptable lowest frequencies of the four extensible whip antenna elements 3a, 3b, 3c and 3d and the polarized states of the incoming waves are horizontally polarized waves, the lengths of the four extensible whip antenna elements 3a, 3b, 3c and 3d are respectively brought to an extended state in such a ways as to reach the longest length, i.e., a length close to one quarter-wavelength of the lowest frequency, and the four extensible whip antenna elements 3a, 3b, 3c and 3d are respectively set so as to be brought into a state close to the horizon with respect to the flat portion 1a, then the incoming radio waves can be received in a satisfactory state with a high degree of antenna efficiency.

When the frequency of the incoming radio waves is of an intermediate frequency lying in an adaptable frequency band for the four extensible whip antenna elements 3a, 3b, 3c and 3d, the lengths of the four extensible whip antenna elements 3a, 3b, 3c and 3d are respectively set so as to be an intermediate length, i.e., a length close to one quarter-wavelength of the intermediate frequency as illustrated by one example in FIG. 1(a). If the vertically polarized wave is predominant as the polarized state of the incoming radio wave at that time, then the four extensible whip antenna elements 3a, 3b, 3c and 3d are respectively set so as to be a state near a state vertical to the flat portion 1a. On the other hand, if the horizontally polarized wave is predominant as the polarized state of the incoming radio wave at that time, then the four extensible whip antenna elements 3a, 3b, 3c and 3d are respectively set so as to be a state close to a state horizontal to the flat portion 1a. If they are set in this way, then the incoming radio waves can be received in a satisfactory state with a high degree of antenna efficiency.

In this case, there is no need to set all of the lengths of the four extensible whip antenna elements 3a, 3b, 3c and 3d to the same length. Further, there is no need to set all of the tilt angles of the four extensible whip antenna elements 3a, 3b, 3c and 3d to the same tilt angle. That is, the lengths of the extensible whip antenna elements 3a, 3b, 3c and 3d may be set so as to differ from one another every extensible whip antenna elements. The tile angles of the extensible whip antenna elements 3a, 3b, 3c and 3d may be set so as to differ from one another every extensible whip antenna elements. Therefore, if there are provided those capable of receiving the incoming radio waves in a satisfactory state with a high degree of antenna efficiency by means of the four extensible whip antenna elements 3a, 3b, 3c and 3d comprehensively, then they can be set in any wise.

As a modification of the direction finder antenna according to the first embodiment, the constructions of the slide bearings of the four antenna holding portions 2a, 2b, 2c and 2d for holding the four extensible whip antenna elements 3a, 3b, 3c and 3d are changed, thereby making it possible to enlarge the rotatable ranges of the four extensible whip antenna elements 3a, 3b, 3c and 3d, specifically, to rotatably set the four extensible whip antenna elements 3a, 3b, 3c and 3d to arbitrary angular positions in hemispherical areas formed on the antenna upright-provided surface side lying within spherical areas with respective antenna upright-provided points of antenna upright-provided surfaces as the centers.

In this case, the direction finder antenna according to the first embodiment and the direction finder antenna according to the modification are essentially identical in function to each other, and their explanations are hence dual. Therefore, the description of the function of the direction finder antenna according to the modification is omitted. Comparing the direction finder antenna according to the modification with the direction finder antenna according to the first embodiment, however, the movable ranges of the four extensible whip antenna elements 3a, 3b, 3c and 3d of the former are enlarged. Therefore, the tilt directions and angles of the four extensible whip antenna elements 3a, 3b, 3c and 3d can be set freely and optionally depending upon the polarized states of the incoming waves.

### Second Preferred Embodiment

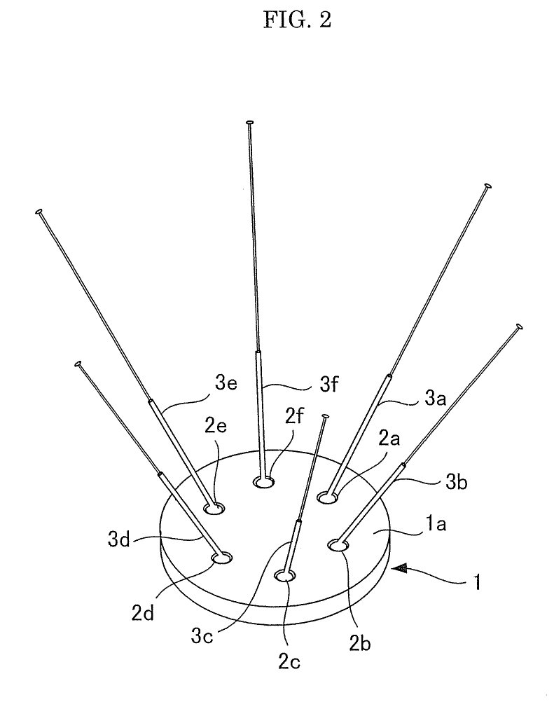

Next, FIG. 2 shows a second embodiment of a direction finder antenna according to the present invention and is a perspective view illustrating a configuration of its essential part. FIG. 2 shows an example in which six extensible whip antenna elements are upright provided on a flat portion.

As shown in FIG. 2, the direction finder antenna according to the second embodiment comprises an antenna mount 1 disc-shaped and formed with a flat portion 1a at one main surface thereof, six antenna holding portions 2a, 2b, 2c, 2d, 2e and 2f which are disposed on the flat portion 1a and constitute slide bearings, and six extensible whip antenna elements 3a, 3b, 3c, 3d, 3e and 3f respectively held by the antenna holding portions 2a, 2b, 2c, 2d, 2e and 2f and upright provided rotatably on the flat portion 1a. Even in this case, the six antenna holding portions 2a, 2b, 2c, 2d, 2e and 2f are disposed at equal intervals on one circumference formed on the flat portion 1a. The ranges in which the six extensible whip antenna elements 3a, 3b, 3c, 3d, 3e and 3f held by the six antenna holding portions 2a, 2b, 2c, 2d, 2e and 2f are rotatable, are placed in circular areas of 180° containing the radial direction of the one circumference, which are formed on the antenna upright-provided surface side, and can rotatably be set to arbitrary angular positions in the circular areas, centering on the six antenna holding portions 2a, 2b, 2c, 2d, 2e and 2f corresponding to antenna upright-provided points of the six extensible whip antenna elements 3a, 3b, 3c, 3d, 3e and 3f. Alternatively, the rotatable ranges are constructed so as to be capable of being rotatably set to arbitrary angular positions in hemispherical areas lying on the flat portion 1a side, of spherical areas with the corresponding six antenna holding portions 2a, 2b, 2d, 2d, 2e and 2f as the centers.

The direction finder antenna according to the second embodiment based on the above configuration is substantially identical in function to the direction finder antenna according to the first embodiment, and its dual explanations are made. Therefore, the function of the direction finder antenna according to the second embodiment will not be explained. Comparing the direction finder antenna according to the second embodiment with the direction finder antenna according to the first embodiment, however, finer adjustments can be carried out by the increased number of used extensible whip antenna elements 3a, 3b, 3c, 3d, 3e and 3f.

Although the first and second embodiments have respectively been explained by citing, as the number of extensible whip antenna elements employed in this type of direction finder antenna, the examples of the four extensible whip antenna elements 3a, 3b, 3c and 3d and the six extensible whip antenna elements 3a, 3b, 3c, 3d, 3e and 3f, the number of the extensible whip antenna elements employed in the direction finder antenna of the present invention is not limited to the four extensible whip antenna elements and the six extensible whip antenna elements. The number of extensible whip antenna elements other than the above, e.g., eight extensible whip antenna elements or twelve extensible whip antenna elements may be used.

Incidentally, the direction finder antenna according to the first embodiment of the present invention, the direction finder antenna according to the modification and the direction finder antenna according to the second embodiment may be used, as their usage forms, not only in a state in which as shown in FIGS. 1(a) and 1(b) and FIG. 2, the extensible whip antenna elements 3a, 3b, 3c or 3d or 3a, 3b, 3c, 3d, 3e and 3f are upright provided in an upper direction with respect to the flat portion 1a of the antenna mount 1 but also in a state in which the extensible whip antenna elements 3a, 3b, 3c and 3d or 3a, 3b, 3c, 3d, 3e and 3f are upright provided in a lower direction or downward with respect to the flat portion 1a of the antenna mount 1.

Although not shown in FIGS. 1(a) and 1(b) and FIG. 2, the antenna mount 1 is provided with an antenna mount holding portion at its part. The antenna mount 1 may preferably be disposed fixedly by means of the antenna mount holding portion to use the direction finder antenna in a fixed state.

### Third Preferred Embodiment

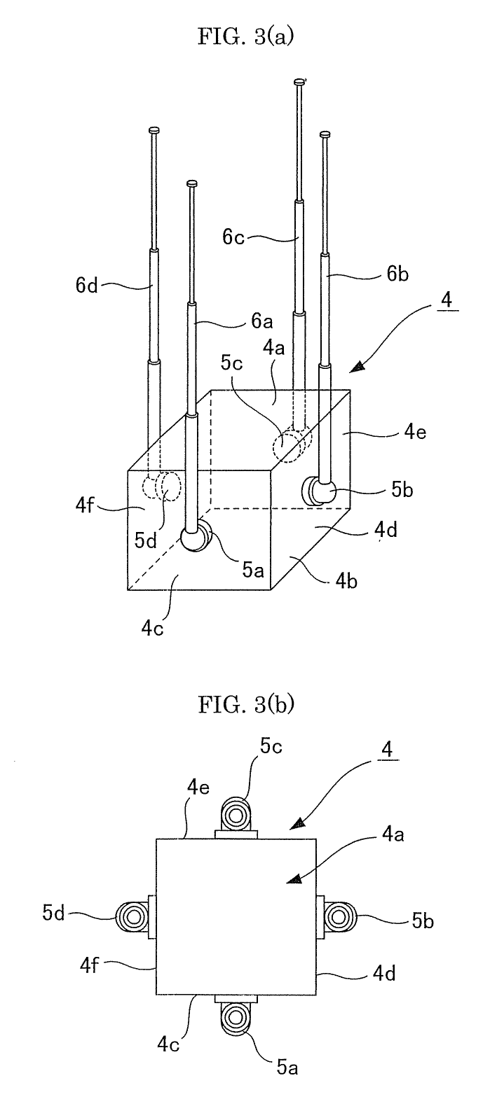

Next, FIGS. 3(a) and 3(b) respectively relate to a third embodiment of a direction finder antenna according to the present invention and shows a configuration of its essential part. The figures show an example using four extensible whip antenna elements. FIG. 3(a) is a perspective view showing a state in which the four extensible whip antenna elements are aimed in the same upper direction and their lengths are extended relatively long, and FIG. 3(b) is a top view showing a state in which the four extensible whip antenna elements are aimed in the same upper direction. In FIG. 3(b), an illustration of the four extensible whip antenna elements is omitted.

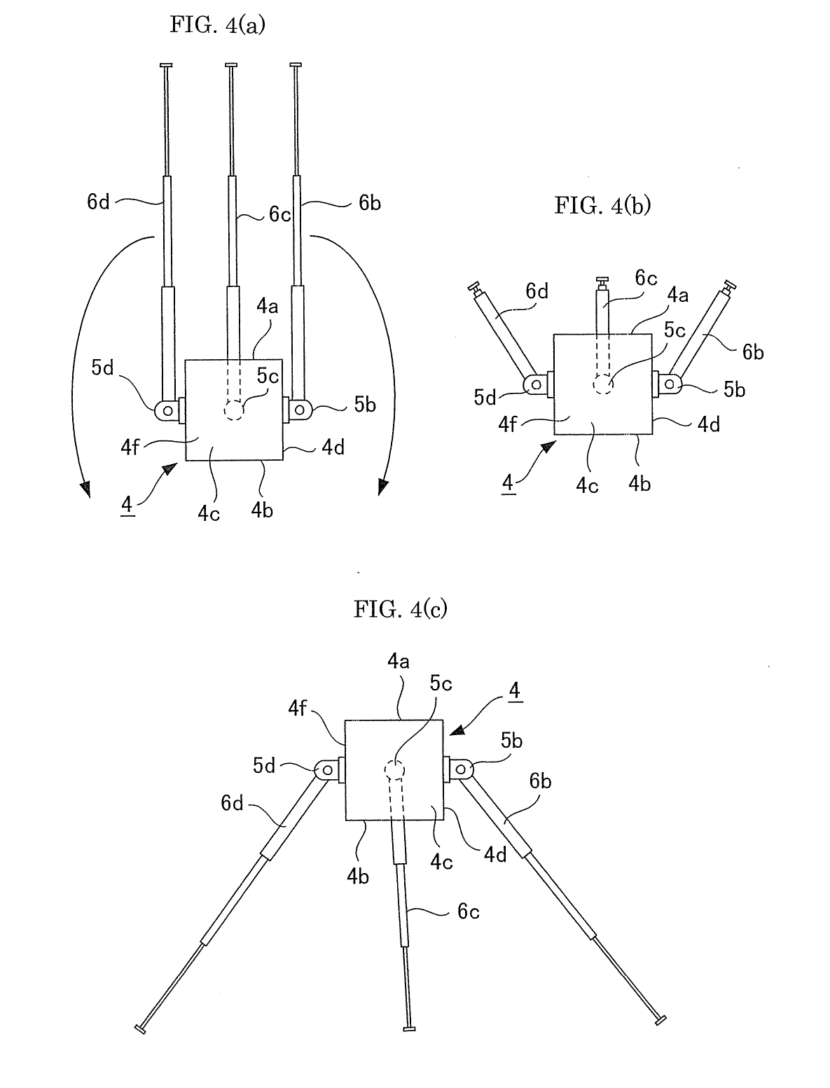

FIGS. 4(a), 4(b) and 4(c) are respectively perspective views showing the states of changes in the extensible whip antenna elements of the direction finder antenna according to the third embodiment, wherein FIG. 4(a) shows an example in which the four extensible whip antenna elements are aimed in the same upper direction and their lengths are extended relatively long, FIG. 4(b) shows an example in which the four extensible whip antenna elements are respectively aimed in an upward direction with being placed in a slightly spread state and their lengths are substantially reduced, and FIG. 4(c) shows an example in which the four extensible whip antenna elements are aimed in a downward direction with being placed in a slightly spread state and their lengths are extended relatively long. Incidentally, the illustrations of one extensible whip antenna elements and antenna holding portions respectively placed toward the front are omitted from FIGS. 4(a), 4(b) and 4(c) like the grasping of their shapes is easy.

As shown in FIGS. 3(a) and 3(b), the direction finder antenna according to the third embodiment is approximately cubic in shape and comprises an antenna mount 4 having an upper surface portion 4a and a lower surface portion 4b substantially identical in area and four side surface portions 4c, 4d, 4e and 4f which respectively constitute antenna upright-provided surfaces and are substantially identical in area, four antenna holding portions 5a, 5b, 5c and 5d formed with slide bearings, and four extensible whip antenna elements 6a, 6b, 6c and 6d held by the antenna holding portions 5a, 5b, 5c and 5d and respectively upright provided rotatably on the corresponding side surface portions 4c, 4d, 4e and 4f.

In this case, the four antenna holding portions 5a, 5b, 5c and 5d are disposed in substantially central positions of their corresponding side surface portions 4c, 4d, 4e and 4f. Thus, the four antenna holding portions 5a, 5b, 5c and 5d are disposed on one straight line that connects vertical about-half points of the four side surface portions 4c, 4d, 4e and 4f. Rotatable ranges of the four extensible whip antenna elements 6a, 6b, 6c and 6d are placed in 180-degree circular areas each including the direction orthogonal to the one straight line, which are formed on their corresponding antenna upright-provided surface sides and can rotatably be set to arbitrary angular positions in the circular areas, centering on the four antenna holding portions 5a, 5b, 5c and 5d corresponding to antenna upright-provided points of the four extensible whip antenna elements 6a, 6b, 6c an 6d.

Even in the direction finder antenna according to the present embodiment, although not shown in FIGS. 3(a) and 3(b), the antenna mount 4 is provided with an antenna mount holding portion at its part. It is preferable that when the direction finder antenna is used, the antenna mount 4 is fixedly disposed by means of the antenna mount holding portion and the direction finder antenna is used in a fixed state.

If, where the frequency of an incoming radio wave is close to an adaptable lowest frequency of each of the four extensible whip antenna elements 6a, 6b, 6c and 6d and a vertically polarized wave is predominant as the state of polarization of the incoming radio wave, the lengths of the four extensible whip antenna elements 6a, 6b, 6c and 6d are respectively brought into an extended state so as to reach a length close to the longest length, i.e., a length close to one quarter-wavelength of the lowest frequency, and the four extensible whip antenna elements 6a, 6b, 6c and 6d are respectively set so as to be directed upward with respect to the antenna mount 4, as illustrated in FIG. 4(a), then the direction finder antenna according to the present embodiment is capable of receiving the corresponding incoming radio wave in a satisfactory state with a high degree of antenna efficiency.

If, where the angle of incidence of the incoming radio wave is slightly upward with respect to the horizontal plane, and the frequency of the incoming radio waves is close to adaptable highest frequencies of the four extensible whip antenna elements 6a, 6b, 6c and 6d and a vertically polarized wave is predominant as the state of polarization of the incoming radio wave, the lengths of the four extensible whip antenna elements 6a, 6b, 6c and 6d are respectively brought to a reduced state in such a way as to reach a length close to the shortest length, i.e., a length close to one quarter-wavelength of the highest frequency, and the four extensible whip antenna elements 6a, 6b, 6c and 6d are respectively set so as to be directed upward with tilt angles between the respective four extensible whip antenna elements 6a, 6b, 6c and 6d being respectively kept in a slightly spread state, as shown in FIG. 4(b), then the corresponding incoming radio wave can be received in a satisfactory state with a high degree of antenna efficiency.

If, where the angle of incidence of the incoming radio wave is slightly downward with respect to the horizontal plane, and the frequency of the incoming radio waves is close to adaptable lowest frequencies of the four extensible whip antenna elements 6a, 6b, 6c and 6d and a vertically polarized wave is predominant as the state of polarization of each incoming radio wave, the lengths of the four extensible whip antenna elements 6a, 6b, 6c and 6d are respectively brought to an extended state so as to reach a length close to the longest length, i.e., a length close to one quarter-wavelength of the lowest frequency, and the four extensible whip antenna elements 6a, 6b, 6c and 6d are respectively set so as to be directed downward with tilt angles between the respective four extensible whip antenna elements 6a, 6b, 6c and 6d being respectively kept in a slightly spread state, as shown in FIG. 4(b), then the corresponding incoming radio wave can be received in a satisfactory state with a high degree of antenna efficiency.

If the frequency of the incoming radio waves is changed upon such a set state, then the lengths of the four extensible whip antenna elements 6a, 6b, 6c and 6d may be extended or reduced depending on its change. Assuming that the state of polarization of the incoming radio wave has changed, the corresponding incoming radio wave can be received in a satisfactory state with a high degree of antenna efficiency in like manner if the four extensible whip antenna elements 6a, 6b, 6c and 6d are respectively brought into a state almost vertical to the horizontal plane, a nearly horizontal state or an intermediate state thereof.

Even in the present embodiment, there is no need to extend and set all of the lengths of the four extensible whip antenna elements 6a, 6b, 6c and 6d to the same length. Further, it is not necessary that the tilt angles of the four extensible whip antenna elements 6a, 6b, 6c and 6d are also set to similar tilt angles. That is, the lengths of the extensible whip antenna elements 6a, 6b, 6c and 6d may be set so as to differ every extensible whip antenna elements. The tilt angles of the extensible whip antenna elements 6a, 6b, 6c and 6d may be set so as to differ every extensible whip antenna elements Therefore, if there are provided those capable of receiving the incoming radio waves in a satisfactory state with a high degree of antenna efficiency by means of the four extensible whip antenna elements 6a, 6b, 6c and 6d comprehensively, then they may be set in any wise.

As a modification of the direction finder antenna according to the third embodiment, the constructions of the slide bearings of the four antenna holding portions 5a, 5b, 5c and 5d for holding the four extensible whip antenna elements 6a, 6b, 6c and 6d are changed, thereby making it possible to enlarge the rotatable ranges of the four extensible whip antenna elements 6a, 6b, 6c and 6d, specifically, to rotatably set the four extensible whip antenna elements 6a, 6b, 6c and 6d to arbitrary angular positions in hemispherical areas formed on their antenna upright-provided surface sides, lying within spherical areas with antenna upright-provided points of their antenna upright-provided surfaces as the centers.

In this case, the direction finder antenna according to the third embodiment and the direction finder antenna according to the modification are essentially identical in function to each other. In order to avoid their dual explanations, the description of the function of the direction finder antenna held by the modification is omitted. Comparing the direction finder antenna according to the modification with the direction finder antenna according to the third embodiment, however, the movable ranges of the four extensible whip antenna elements 6a, 6b, 6c and 6d of the former are enlarged. Therefore, the tilt directions and angles of the four extensible whip antenna elements 6a, 6b, 6c and 6d can be set freely and optionally depending upon the polarized states of the incoming waves.

Although the direction finder antenna according to each of the third embodiment and the modification has been explained by citing the example in which the antenna mount 4 makes use of one shaped in the form of an approximately cubic and the four extensible whip antenna elements 6a, 6b, 6c and 6d are upright provided, this type of antenna mount 4 is not limited to the approximately cubic shape in the direction finder antenna according to the present invention. Further, the number of the antenna elements upright provided corresponding to the shape of the antenna mount 4 is not limited to four.

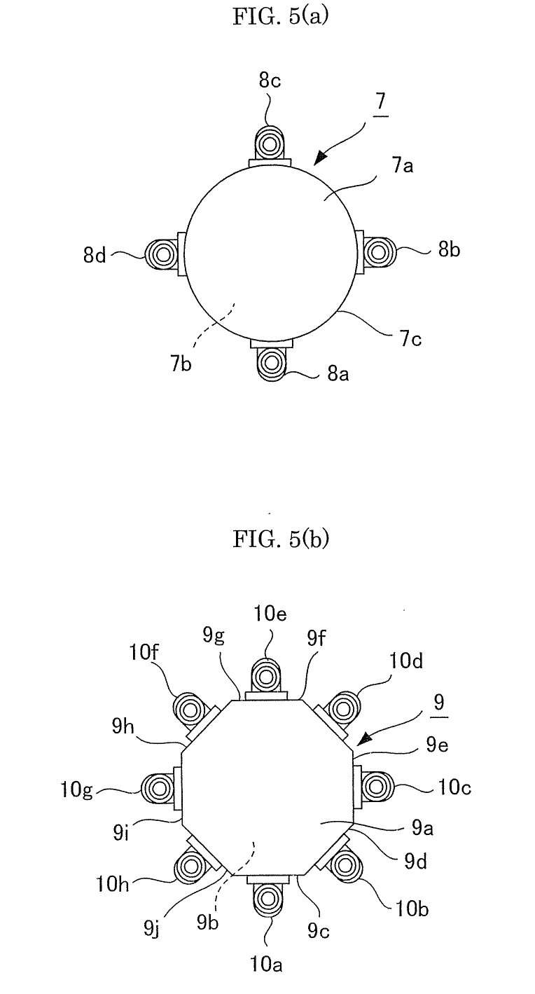

Now, FIGS. 5(a) and 5(b) respectively show examples in which ones having shapes other than the approximately cubic shape are used as antenna mounts, wherein FIG. 5(a) is an example in which a cylindrical one whose upper and lower surface portions are circular is used as the antenna mount and four extensible whip antenna elements are upright provided, and FIG. 5(b) is an example in which a polygonal-prism shaped one whose upper and lower surface portions are regular octagonal is used as the antenna mount and eight extensible whip antenna elements are upright provided. Like the grasping of the states of their shapes is easy in FIGS. 5(a) and 5(b), only antenna holding portions are illustrated and the illustrations of extensible whip antenna elements are omitted.

The example shown in FIG. 5(a) comprises an antenna mount 7 having circular upper and lower surface portions 7a and 7b approximately cylindrical and substantially identical in area to each other and a side surface portion 7c that forms antenna upright-provided surfaces and shaped in cylindrical form, four antenna holding portions 8a, 8b, 8c and 8d disposed on the side surface portion 7c at equal intervals and formed with slide bearings, and four extensible whip antenna elements (not shown) respectively held by the antenna holding portions 8a, 8b, 8c and 8d and upright provided rotatably on the side surface portion 7c. In this case, the four antenna holding portions 8a, 8b, 8c and 8d are disposed on a straight line that connects positions each corresponding to about half the height of the side surface portion 7c.

The example shown in FIG. 5(b) comprises an antenna mount 9 having square-shaped upper and lower surface portions 9a and 9b shaped in octagonal-prism (polygonal-prism) form and approximately identical in area and eight rectangular side surface portions 9c, 9d . . . , 9j, eight antenna holding portions 10a, 10b . . . , 10h respectively disposed substantially in the central positions of the side surface portions 9c, 9d, . . . , 9j and formed with slide bearings, and eight extensible whip antenna elements (not shown) respectively held by the antenna holding portions 10a, 10b . . . , 10h and upright provided rotatably on their corresponding side surface portions 9c, 9d . . . , 9j.

Even in the case of the examples shown in FIGS. 5(a) and 5(b), the respective ranges in which the extensible whip antenna elements are movable are identical to the movable ranges of the extensible whip antenna elements employed in the direction finder antenna according to the third embodiment or set identical to the movable ranges of the extensible whip antenna elements according to the modification thereof. The function of the example shown in FIG. 5(a) is almost identical to the function of the direction finder antenna according to the third embodiment. The function of the example shown in FIG. 5(b) is almost identical to the function of the modification of the direction finder antenna according to the third embodiment. Even in the examples shown in FIGS. 5(a) and 5(b), fine adjustments can be carried out as the number of the used extensible whip antenna elements increases.

While the preferred forms of the present invention have been described, it is to be understood that modifications will be apparent to those skilled in the art without departing from the spirit of the invention. The scope of the invention is to be determined solely by the following claims.

What is claimed is:

1. A direction finder antenna comprising:
an antenna mount having at least one flat portion; and
extensible whip antenna elements of four or more which use the flat portion of the antenna mount as an antenna upright-provided surface and are respectively upright provided rotatably at antenna upright-provided points formed on one circumference at the antenna upright-provided surface,
wherein the extensible whip antenna elements are respectively capable of being rotatably set to arbitrary angular positions lying in sector-shaped areas each having an open angle of 180° orthogonal to the one circumference, which are formed on the antenna upright-provided surface side, centering on the respective antenna upright-provided points at the antenna upright-provided surface.

2. A direction finder antenna comprising:
an antenna mount having at least one flat portion; and
extensible whip antenna elements of four or more which use the flat portion of the antenna mount as an antenna upright-provided surface and are respectively upright provided rotatably at antenna upright-provided points formed on one circumference at the antenna upright-provided surface,
wherein the extensible whip antenna elements are respectively capable of being rotatably set to arbitrary angular positions in hemispherical areas formed on the antenna upright-provided surface side, lying in spherical areas with respective antenna upright-provided points at the antenna upright-provided surface as the centers.

3. A direction finder antenna comprising:
an antenna mount having upper and lower surface portions and side surface portions formed so as to connect side edges of the upper surface portion and side edges of the lower surface portion; and
a plurality of extensible whip antenna elements which respectively use the side surface portions of the antenna mount as antenna upright-provided surfaces and are respectively upright provided rotatably at antenna upright-provided points formed at plural equal intervals on a straight line connecting the same vertical positions at the antenna upright-provided surfaces,
wherein the extensible whip antenna elements are respectively capable of being rotatably set to arbitrary angular positions lying in sector-shaped areas each having an open angle of 180° orthogonal to the straight line formed on the antenna upright-provided surfaces sides, centering on the respective antenna upright-provided points at the antenna upright-provided surfaces.

4. A direction finder antenna comprising:
an antenna mount having upper and lower surface portions and side surface portions formed so as to connect side edges of the upper surface portion and side edges of the lower surface portion; and
a plurality of extensible whip antenna elements which respectively use the side surface portions of the antenna mount as antenna upright-provided surfaces and are respectively upright provided rotatably at antenna upright-provided points formed at plural equal intervals on a straight line connecting the same vertical positions at the antenna upright-provided surfaces,
wherein the extensible whip antenna elements are respectively capable of being rotatably set to arbitrary angular positions in hemispherical areas formed on the antenna upright-provided surfaces sides, lying in spherical areas with the respective antenna upright-provided points at the antenna upright-provided surfaces as the centers.

5. The direction finder antenna according to claim 3 or 4, wherein the antenna mount has upper and lower surface portions each shaped in the form of an approximately square, and a plurality of extensible whip antenna elements are respectively provided at antenna upright-provided points respectively formed at positions corresponding to respective sides of the approximately squares at antenna upright-provided surfaces.

6. The direction finder antenna according to claim 3 or 4, wherein the antenna mount includes upper and lower surface portions whose shapes are approximately circular, and a plurality of extensible whip antenna elements are respectively provided at antenna upright-provided points respectively formed at positions each corresponding to a circumferential area shaped in the approximately circular form at an antenna upright-provided surface.

7. The direction finder antenna according to claim 3 or 4, wherein the antenna mount has upper and lower surface portions whose shapes are approximately equilateral pentagonal or regular polygonal greater than the equilateral pentagon, and a plurality of extensible whip antenna elements are respectively provided at antenna upright-provided points respectively formed at positions corresponding to respective sides of the approximately regular polygon at antenna upright-provided surfaces.
